(19) United States
(12) Patent Application Publication
(10) Pub. No.: US 2014/0066129 A1
(43) Pub. Date: Mar. 6, 2014

(54) Touch-Screen Mobile Electronic Communication Device and Controller

(71) Applicants: Dian Zhu, Chantilly, VA (US); Nicholas Singhal, New York, NY (US)

(72) Inventors: Dian Zhu, Chantilly, VA (US); Nicholas Singhal, New York, NY (US)

(21) Appl. No.: 13/553,813

(22) Filed: Jul. 20, 2012

Related U.S. Application Data
(60) Provisional application No. 61/671,070, filed on Aug. 30, 2012.

(51) Int. Cl. H04W 88/02

(52) U.S. Cl. 455/566

(57) ABSTRACT

A touch-screen mobile electronic cellular/communication devices having ergonomic buttons and controls for improved control of gaming activities, for interface with and control of a gaming console without the need for a game controller, and for remote control of home entertainment devices, home appliances, furniture, transportation vessels (automobile, aircraft, water vehicles, submersibles), machinery, robots, weapons, sports equipment, other consumer electronics, security devices, musical instruments, toys, recreational hobby/devices, and other devices that can be controlled through wireless signal input.

### REFERENCE TO CO-PENDING APPLICATION

The following patent application is hereby incorporated by reference:

U.S. provisional patent application Ser. No. 61/671,070 filed Jul. 12, 2012 entitled “Touch-screen Mobile Electronic Device and Controller” by the same inventors as the present application.

### REFERENCES CITED

### U.S. Patent Documents

| | | |
|---|---|---|
| 4,349,708 | September 1982 | Asher |
| 4,469,330 | September 1984 | Asher |
| 5,207,426 | May 1993 | Inoue et al |
| 5,689,285 | November 1997 | Asher |
| 5,451,053 | September 1995 | Garrido |
| 5,700,194 | December 1997 | Hsien |
| 5,759,100 | June 1998 | Nakanishi |
| 6,231,444 | May 2001 | Goto et al |
| 6,392,634 | May 2002 | Bowers et al |

### BACKGROUND OF THE INVENTION

1. Field of the Invention

The present invention relates to touch-screen mobile electronic cellular/communication devices, such as cellular telephones, PDAs, and tablets, and more particularly to ergonomics during utilization of the mobile electronic device as a remote controller or remote control device and game controller or gaming device.

2. Description of Prior Art

Touch-screen mobile electronic cellular/communication devices come in many different designs and sizes. While they are often used to control other devices and for gaming, users of these devices primarily interface with the touch-screen to control these activities. Such interfaces make user control of these activities particularly difficult and inefficient as compared to the control achieved from typical (with physical buttons) remote controllers and game controllers as touch-screen feedback/sensitivity lag makes fast inputs and precision control very difficult. Most, if not all, commercially available touch-screen mobile electronic cellular/communication devices are rectangular in shape. Accordingly, the preferred embodiment of the invention described herein incorporates a rectangular shape and is most applicable to rectangular-shaped touch-screen mobile electronic cellular/communication devices.

According to the Webster's® dictionary “ergonomics” is defined as “an applied science concerned with designing and arranging things people use so that the people and things interact most efficiently and safely.” Thus, with respect to mobile electronic devices, ergonomics clearly relates to how the device sits in the user's hands and how the user can effectively and efficiently use the buttons and controls without undue strain on his or her hands.

Most commercially available touch-screen mobile electronic cellular/communication devices have very few buttons as the primary user-interface is the touch-screen. Aesthetics are an important consideration with respect to the design of touch-screen mobile electronic cellular/communication devices. In addition to the ergonomic and remote control gaming utilities, the invention described herein accomplishes the aforementioned utilities while maintaining an aesthetic design, which is visually very similar to commercially available touch-screen mobile electronic cellular/communication devices and could be applied to such existing devices without significant alteration of the overall appearance of the device.

With respect to control of gaming consoles, game controllers specifically designed for interface with particular gaming consoles are the industry standard and are the only commercially available options for control of gaming console activities. The invention described herein also accomplishes the utility of interfacing with gaming consoles to allow users to control gaming console activities without requiring use of a game controller.

While there are many prior art game controllers, no prior art touch-screen mobile electronic cellular/communication devices with gaming controls were identified. A typical prior art game controller is shown in U.S. Pat. No. 5,207,426 issued May 4, 1993 to Y. Inoue et al and assigned to Nintendo Co. Ltd. The Nintendo controller is a typical example of a game controller having multiple inputs capable of manipulating multiple axes, such as with the cross-shaped keypad and numerous buttons and depressible surfaces. As with most game controllers, the Nintendo controller includes a housing to be grasped and held simultaneously by two hands of a human user with thumbs of the grasping hands remaining free of grasping responsibilities so that the cross-shaped keypad can be depressed with the left thumb and the other gaming buttons with the right thumb.

Other related prior art of which we are aware and believe to be cumulative to the aforementioned includes the following game controllers and controls: U.S. Pat. No. 4,349,708 issued on Sep. 14, 1982, U.S. Pat. No. 4,469,330 issued on Sep. 4, 1984, U.S. Pat. No. 5,451,053 issued on Sep. 19, 1995, U.S. Pat. No. 5,689,285 issued on Nov. 18, 1997, U.S. Pat. No. 5,700,194 issued Dec. 23, 1997, U.S. Pat. No. 5,759,100 issued Jun. 2, 1998, U.S. Pat No. 6,231,444 issued May 15, 2001, and U.S. Pat. No. 6,392,634 issued May 21, 2002.

### SUMMARY OF THE INVENTION

It is an objective of the invention to provide a touch-screen mobile electronic cellular/communication device having specifically oriented buttons and/or controls for maximizing user comfort and efficiency in control of gaming activities and/or in use as a remote control.

It is yet another objective of the invention to provide a touch-screen mobile electronic cellular/communication device having specifically oriented buttons and/or controls while maintaining an aesthetic appearance generally consistent with those of other existing commercially available touch-screen mobile electronic cellular/communication devices.

It is yet another objective of the invention to provide a touch-screen mobile electronic cellular/communication device having the ability to interface with other devices through a wireless network connection, Bluetooth, infrared, radio wave or other means allowing the user to control other devices, such as for remote control of home entertainment devices, home appliances, furniture, transportation vessels (automobile, aircraft, water vehicles, submersibles), machinery, robots, weapons, sports equipment, other consumer electronics, security devices, musical instruments, toys, recreational hobby/devices, and other devices that can be controlled through wireless signal input.

These and other objectives are achieved in accordance with an embodiment of the invention wherein the touch-screen mobile electronic cellular/communication device includes a body having a plurality of buttons or controls in a specific orientation for efficient and comfortable control of gaming and other activities.

A joystick, four-directional control pad, or rolling ball control allows the user to more easily, comfortably and accurately control gaming movement as compared to movement control using a touch-screen. Eight buttons oriented in pairs at the four corners of the device allow the user to more easily, comfortably and accurately control gaming activities in a right-handed or left-handed orientation as compared to use of touch-screen. The specific design orientation provides for comfortable use of the device as a game controller for a gaming console as well.

Other objects and features of the present invention will become apparent from the following detailed description considered in conjunction with the accompanying drawings.

It is to be understood however that the drawings are designed solely for purposes of illustration and not as a definition of the limits of the invention for which reference should be made to the appended claims. It should be further understood that the drawings are not necessarily drawn to scale and that unless otherwise indicated they are merely intended to conceptually illustrate the structures and procedures described herein.

### BRIEF DESCRIPTION OF THE DRAWINGS

In the drawings wherein like reference numerals denote similar components throughout the views:

FIG. 1A is a front view of the touch-screen mobile electronic cellular/communication devices according to an embodiment of the invention.

FIG. 1B is a front perspective view according to an embodiment of the invention.

FIG. 2A is an exploded view of an embodiment of the invention.

FIG. 2B is a left-side perspective view of the body of an embodiment of the invention.

FIG. 2C is a right-side perspective view of the body of an embodiment of the invention.

### DETAILED DESCRIPTION OF PREFERRED EMBODIMENT

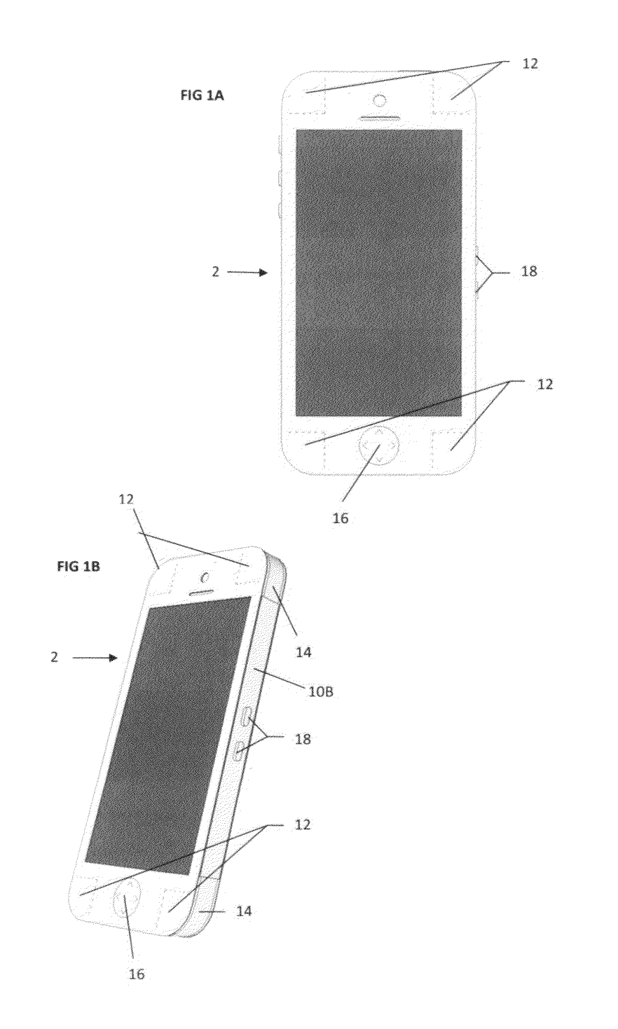

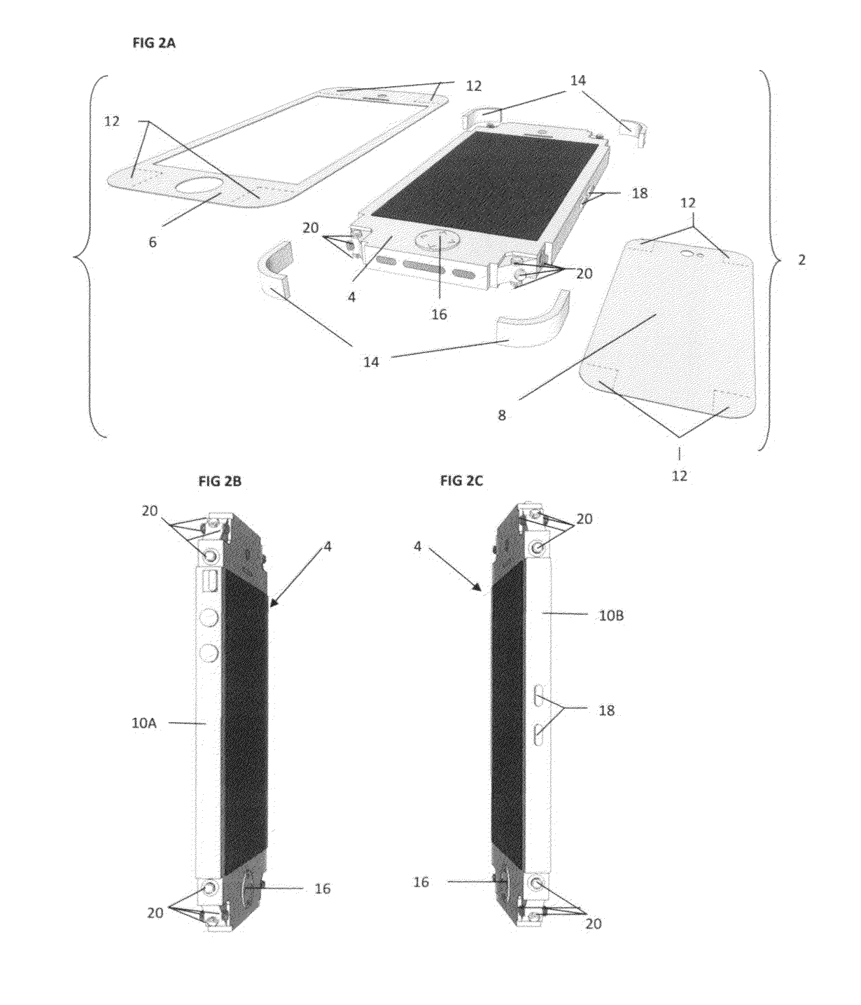

Referring to FIGS. 1 and 2, there is shown the touch-screen mobile electronic cellular/communication devices 2 according to the present invention. The touch-screen mobile electronic cellular/communication device 2 includes a body portion 4 and a plurality of user controls 12, 14, 16, and 18.

In accordance with an embodiment of the invention, the body portion consists of an exterior shell with a front panel 6, rear panel 8, and side panels 10A and 10B, which house the internal electronic components. Front and rear gaming controls 12 are not visually distinct from the exterior shell of the body and can be user-operated by application of pressure on any of the four corners of the top panel of the device. The four corners of the top panel are flexible, and thus, can be depressed to activate user controls.

In accordance with this embodiment referring to FIG. 2A, the four corners of the front panel 6 are not fused to the side panels 10A and 10B, allowing for depression of the corners to activate user controls. Therefore, the aesthetic appearance of the touch-screen electronic device is maintained without the existence of protruding buttons on the top panel, while providing users with ergonomic game controller functionality.

In accordance with this embodiment, the side panels house components for speakers, power source, audio output interface, screen on/off control, ring/silent control, SIM card, volume control, power control, as well as for “select” and “start” buttons 18 and side controls 14. The side controls 14 and “select” and “start” buttons 18 of present invention are intended as gaming controls and are positioned for ergonomic control of the device during use as a game controller for the comfortable and efficient use of the same. “Select” and “start” buttons are commonly used in the gaming industry on game controllers for control of specific gaming activities. However, the “start” and “select” buttons may be used for other functions and user-controlled activities.

In accordance with this embodiment referring to FIG. 2A, the front panel 6 and rear panel 8 house components for camera lens, camera flash, speaker, and a joystick, and or four-directional control pad, and or rolling ball control 16. The front panel 6 and rear panel 8 are flexible at all four corners providing the front and rear gaming controls 12. The joystick, four-directional control pad, or rolling ball control 16 and front and rear gaming controls 12 of the present invention are intended as directional controls and are positioned for ergonomic control of the device during use as a remote controller and or game controller for the comfortable and efficient use of the same.

With respect to gaming and remote control activities, it is ergonomic and efficient for a user to control direction and movement of target objects using his or her thumb from either hand depending on preference for right-handed or left-handed orientation. Thus, the margin area of the front panel is optimal for the location of a joystick, four-directional control pad, or rolling ball control 16 as the user can easily hold and view the screen of the device while maneuvering the directional control with his or her thumb. To switch from right-handed to left-handed orientation the user simply needs to invert the device. It is also ergonomic and efficient for a user to control non-movement activities using non-thumb fingers as the thumbs are used for control of directional control and for holding the device. Thus, the front, rear, and side gaming controls are optimally located for comfortable use with non-thumb fingers.

In accordance with this embodiment referring to FIGS. 2B and 2C, the side controls 14 and front and rear gaming controls 12 attach to rubber or plastic tactile button pads 20, which when depressed, signal to the internal circuitry of the device to effectuate user control of gaming activities.

In accordance with other embodiments of the invention, controls/buttons 12, 14, 16, and 18 can be configured in different shapes and sizes depending on the touch-screen mobile electronic cellular/communication device and the particular use for which it is intended. Those of skill in the art understand that the actual shape and design of touch-screen mobile electronic cellular/communication devices and corresponding controls is a matter of design choice and may be changed without departing the spirit of the present invention.

While there have been shown and described fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form embodiment of the invention may be incorporated in any other disclosed, described, or suggested form or embodiment as a general matter of design choice. It is the intention, therefore, to be limited only as indicated by the scope of the claims appended hereto.

What is claimed is:

1. A touch-screen mobile electronic cellular/communication device comprising:
a body having a plurality of gaming controls; and
at least one control connected to said body and having at least two operable positions with respect to the gaming controls to allow for multi-directional control.

2. The touch-screen mobile electronic cellular/communication device according to claim 1, wherein said at least one control comprises a four-directional control pad connected to said body.

3. The touch-screen mobile electronic cellular/communication device according to claim 1, wherein said at least one control comprises a joystick connected to said body.

4. The touch-screen mobile electronic cellular/communication device according to claim 1, wherein said at least one control comprises a rolling ball connected to said body.

5. The touch-screen mobile electronic cellular/communication device according to claim 1, wherein said gaming controls allow the user to control external devices through a wireless network connection, Bluetooth, infrared, radio wave or other wireless means.

6. A touch-screen mobile electronic cellular/communication device comprising:
a body having a plurality of gaming controls;
at least one control connected to said body and having at least two operable positions with respect to the gaming controls to allow for multi-directional control; and
a front panel, rear panel, and side panels for housing device components and said plurality of gaming controls.

7. The touch-screen mobile electronic cellular/communication device according to claim 6, wherein said at least one control comprises a four-directional control pad connected to said body.

8. The touch-screen mobile electronic cellular/communication device according to claim 6, wherein said at least one control comprises a joystick connected to said body.

9. The touch-screen mobile electronic cellular/communication device according to claim 6, wherein said at least one control comprises a rolling ball connected to said body.

10. The touch-screen mobile electronic cellular/communication device according to claim 6, wherein all four corners of said front panel and rear panel comprise depressible controls which can be oriented in the desired operable position by the user.

11. The touch-screen mobile electronic cellular/communication device according to claim 6, wherein tactile button pads are connected to said body for transduction of signals from user activation of controls to the internal circuitry of said device.

12. The touch-screen mobile electronic cellular/communication device according to claim 6, wherein said side panels house controls for depression by the user's index fingers in the desired orientation of said device.

13. The touch-screen mobile electronic cellular/communication device according to claim 6, wherein one of said side panels houses controls for “select” and “start” gaming buttons.

14. The touch-screen mobile electronic cellular/communication device according to claim 6, wherein said gaming controls allow the user to control external devices through a wireless network connection, Bluetooth, infrared, radio wave or other wireless means.
